(19) United States
(12) Patent Application Publication
(10) Pub. No.: US 2025/0269822 A1
(43) Pub. Date: Aug. 28, 2025

(54) ADAPTER FOR WIPER

(71) Applicant: CAP CORPORATION, Sangju-si (KR)

(72) Inventor: Young Hun LIM, Sangju-si (KR)

(73) Assignee: CAP CORPORATION, Sangju-si (KR)

(21) Appl. No.: 18/928,214

(22) Filed: Oct. 28, 2024

(30) Foreign Application Priority Data
Feb. 28, 2024 (KR) 10-2024-0028669

(51) Int. Cl. B60S 1/38

(52) U.S. Cl. CPC B60S 1/3867; B60S 2001/3843

(57) ABSTRACT

Disclosed is an adapter for connecting a wiper blade to a wiper arm. The adapter includes a body coupled to the wiper blade. The wiper arm is detachably connected to the body; and a locking cap pivotally coupled to a front of the body, wherein the body has, a blade coupling shaft rotatably coupled to the wiper blade; a pair of locking cap coupling shafts rotatably coupled to the locking cap; and a first arm coupling groove recessed in an outer side surface of the body. A portion of the first arm coupling groove is positioned between the blade coupling shaft and the locking cap coupling shaft.

### CROSS-REFERENCE TO RELATED APPLICATION

This application claims priority to Korean Patent Application No. 10-2024-0028669 (filed on Feb. 28, 2024), which is hereby incorporated by reference in its entirety.

### BACKGROUND

The present disclosure relates to an adapter for a wiper, and more specifically, to an adapter for connecting a wiper arm and a wiper blade to each other.

Generally, a wiper device is installed on a vehicle to wipe a surface of a windshield. The wiper device includes a wiper motor, a wiper arm, a wiper blade, etc., and an adapter is used for structural connection between the wiper arm and the wiper blade.

The wiper arm is connected to a rotational shaft of the wiper motor at a base of the arm and reciprocates under an operation of the wiper motor, and may include one or more wiper arm depending on a size of the windshield. When the two wiper arms are provided, they are arranged so that movements thereof do not interfere with each other.

The wiper blade is detachably connected to an end of the wiper arm via the adapter. The wiper blade is provided in a straight shape and maintains a state of close contact with the windshield, and slides and wipes the surface of the windshield under the movement of the rotating wiper arm.

The wiper blade is installed on the vehicle and is continuously rubbed against the windshield. Thus, over time, the blade may wear out, and generate unnecessary noise, or its surface-wiping performance thereof may deteriorate.

Therefore, the wiper blade needs to be continuously replaced. To this end, the vehicle user removes the existing wiper blade from the wiper arm and attaches a new wiper blade thereto using the adapter.

Since wiper arms have various shapes depending on types thereof, the adapter of a structure suitable for the wiper arm is required. In addition, the adapter should make it easy to replace the wiper blade and should allow a state in which the wiper blade attached to the wiper arm is in close contact with the windshield to be stably maintained under wind resistance, etc.

Therefore, development has been done on a structure of the adapter that effectively connects the wiper blade to the wiper arm in consideration of the shape of the wiper arm.

### SUMMARY

A purpose of the present disclosure is to provide an adapter for a wiper that is easily removed from a wiper arm and ensures a strong fastening force between the wiper arm and the wiper blade.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

In order to achieve the above purpose, an adapter for connecting a wiper blade to a wiper arm according to an embodiment of the present disclosure includes a body coupled to the wiper blade, wherein the wiper arm is detachably connected to the body; and a locking cap pivotally coupled to a front of the body, wherein the body has, a blade coupling shaft rotatably coupled to the wiper blade; a pair of locking cap coupling shafts rotatably coupled to the locking cap; and a first arm coupling groove recessed in an outer side surface of the body, wherein a portion of the first arm coupling groove is positioned between the blade coupling shaft and the locking cap coupling shaft.

Specific details of other embodiments are included in the detailed description and drawings.

According to the adapter of the present disclosure, following effects may be achieved.

First, various types of wiper arms may be connected to the adapter, and the wiper arm may be displaced downwardly to the adapter and may be stably connected to the adapter.

Second, the wiper arm protrusions are respectively inserted into the groove defined in the center of rotation of the adapter and the groove defined in the rear portion in rear of the center thereof, so that the wiper blade may move stably when the wiper arm operates.

Third, the button of the locking cap may be easily detached from the body.

Fourth, the locking cap may be pivotally and firmly coupled to the body.

The effects of the present disclosure are not limited to the effects as mentioned above, and other effects not mentioned above will be clearly understood by those skilled in the art from following descriptions.

In addition to the above-described effects, the specific effects of the present disclosure are described below while describing specific details for implementing the embodiments of the present disclosure.

### BRIEF DESCRIPTION OF DRAWINGS

FIG. 1 is a partial perspective view of a wiper device according to one embodiment of the present disclosure.

FIG. 2 is an exploded view of an adapter according to one embodiment of the present disclosure.

FIG. 3 is a partial perspective view of an adapter according to one embodiment of the present disclosure.

FIG. 4 is an exploded view of an adapter according to one embodiment of the present disclosure.

FIG. 5 is a side view of an adapter according to one embodiment of the present disclosure.

FIG. 6 is a drawing showing that a wiper arm is connected to an adapter in a wiper device according to one embodiment of the present disclosure.

### DETAILED DESCRIPTIONS

Advantages and features of the present disclosure, and a method of achieving the advantages and features will become apparent with reference to embodiments described later in detail together with the accompanying drawings. However, the present disclosure is not limited to the embodiments as disclosed under, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for illustrating embodiments of the present disclosure are illustrative, and embodiments of the present disclosure are not limited thereto.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

In addition, it will also be understood that when a first element or layer is referred to as being present “on” a second element or layer, the first element may be disposed directly on the second element or may be disposed indirectly on the second element with a third element or layer being disposed between the first and second elements or layers. It will be understood that when an element or layer is referred to as being “connected to”, or “connected to” another element or layer, it may be directly on, connected to, or connected to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Further, as used herein, when a layer, film, region, plate, or the like is disposed “on” or “on a top” of another layer, film, region, plate, or the like, the former may directly contact the latter or still another layer, film, region, plate, or the like may be disposed between the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between the former and the latter. Further, as used herein, when a layer, film, region, plate, or the like is disposed “below” or “under” another layer, film, region, plate, or the like, the former may directly contact the latter or still another layer, film, region, plate, or the like may be disposed between the former and the latter. As used herein, when a layer, film, region, plate, or the like is directly disposed “below” or “under” another layer, film, region, plate, or the like, the former directly contacts the latter and still another layer, film, region, plate, or the like is not disposed between the former and the latter.

In descriptions of temporal relationships, for example, temporal precedent relationships between two events such as “after”, “subsequent to”, “before”, etc., another event may occur therebetween unless “directly after”, “directly subsequent” or “directly before” is not indicated.

When a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

It will be understood that, although the terms “first”, “second”, “third”, and so on may be used herein to describe various elements, components, regions, layers and/or periods, these elements, components, regions, layers and/or periods should not be limited by these terms. These terms are used to distinguish one element, component, region, layer or section from another element, component, region, layer or period. Thus, a first element, component, region, layer or section as described under could be termed a second element, component, region, layer or period, without departing from the spirit and scope of the present disclosure.

The features of the various embodiments of the present disclosure may be partially or entirely combined with each other, and may be technically associated with each other or operate with each other. The embodiments may be implemented independently of each other and may be implemented together in an association relationship.

It will be understood that when an element or layer is referred to as being “connected to”, or “connected to” another element or layer, it may be directly on, connected to, or connected to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “A and/or B” means A, B or A and B, unless specifically stated otherwise. Expression such as “at least one of” when preceding a list of elements may modify the entirety of list of elements and may not modify the individual elements of the list. As used herein, “C to D” means C inclusive to D inclusive unless otherwise specified.

Hereinafter, the present disclosure will be described with reference to drawings for illustrating an adapter according to embodiments of the present disclosure.

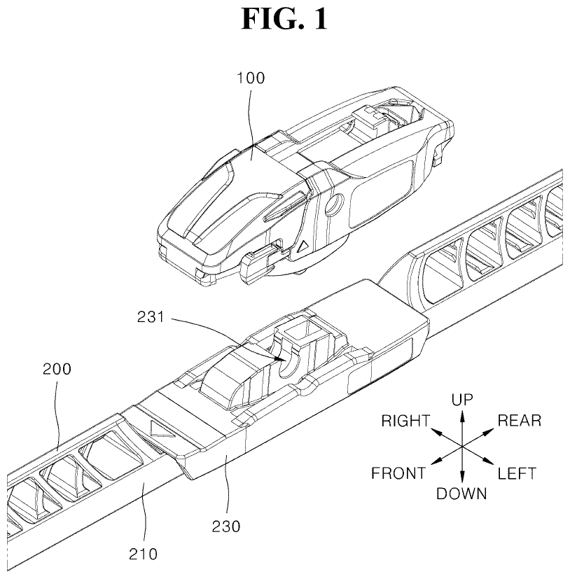

FIG. 1 is a partial perspective view of a wiper device according to one embodiment of the present disclosure.

A wiper device according to one embodiment of the present disclosure includes a wiper blade 200 that is in close contact with a surface of a target object (e.g., a windshield of a vehicle) to wipe the surface of the target object, a wiper arm (not shown) that moves the wiper blade 200, and an adapter 100 that connects the wiper blade 200 to the wiper arm.

The wiper blade 200 includes a base 230 connected to the adapter 100, and a blade portion 210 that extends in an elongate manner in a front-rear direction, and coupled to the base 230, wherein the blade portion 210 has front and rear portions respectively coupled to both opposing ends in the front-rear direction of the base.

The blade portion 210 extends in the front-rear direction, but has a curved bow shape conforming to a shape of the target object. The blade portion 210 is partially made of an elastic member, and the elastic member is in close contact with the target object.

The base 230 is coupled to the blade portion 210 and coupled to the adapter 100. The base 230 is rotatable relative to the adapter 100. The base 230 has a base holder 231 embodied as a roughly cylindrical hole with an upper opening into which the adapter 100 is inserted.

The wiper arm rotates around a shaft disposed on a vehicle. The wiper blade 200 is connected to an end of the wiper arm via the adapter 100 such that the wiper arm moves the wiper blade 200. The wiper arm is detachably connected to the adapter 100.

The wiper arm may have various structures of the end connected to the adapter 100 depending on the target object. In this embodiment, the adapter 100 is embodied as an omni-adapter that may be connected to various types of wiper arms.

The adapter 100 connects various types of wiper arms to the wiper blade 200. The adapter 100 is pivotally connected to the wiper blade 200. The adapter 100 is detachably connected to the wiper arm.

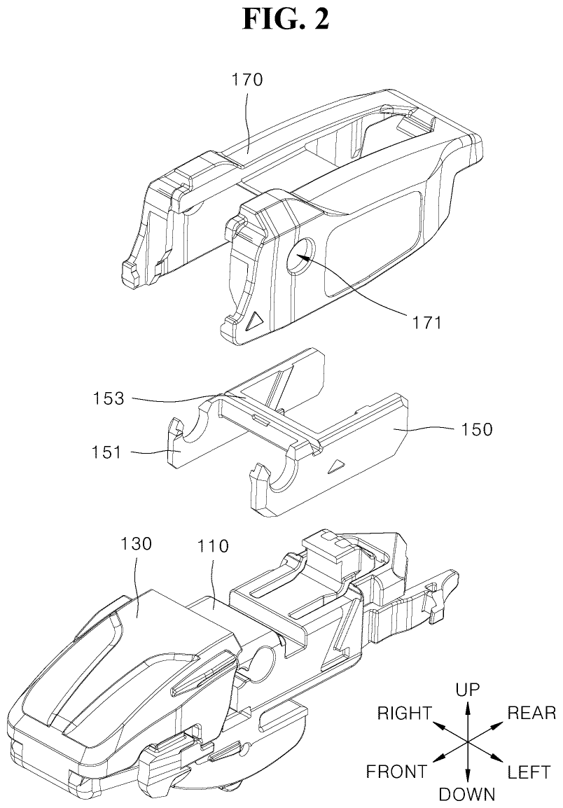

FIG. 2 is an exploded view of an adapter according to one embodiment of the present disclosure.

The adapter 100 according to one embodiment of the present disclosure includes a body 110 that is pivotally coupled to the wiper blade 200 and to which the wiper arm is detachably connected, and a locking cap 130 that is pivotally coupled to a front end of the body 110.

The adapter 100 according to one embodiment of the present disclosure may further include a spacer 150 and a cover 170 that are detachably coupled to the body 110 to connect a specific type of the wiper arm to the wiper blade.

The spacer 150 is configured to increase a width direction (left-direction) dimension of the body 110 and includes a pair of spacer side plates 151 respectively constituting both opposing sides (left and right sides) and a spacer connector 153 that connects the pair of spacer side plates 151 to each other.

The cover 170 is configured to increase the width direction (left-direction) dimension of the body 110 or to change an structure of an upper surface thereof, and has cover holes 171 respectively defined in both opposing sides (left and right sides). The cover holes 171 corresponds to a center hole of the body 110 as described later.

The body 110 is pivotally connected to the base 230 of the wiper blade 200. The body 110 is inserted into the base holder 231 of the base 230. The body 110 have both opposing side surfaces (left and right side surfaces) and the upper surface. The locking cap 130 is pivotally connected to the front end of the body 110.

The locking cap 130 is disposed at the front end of the body 110 and is pivotally connected to the body 110 to connect a specific type of the wiper arm to the wafer blade. The locking cap 130 is composed of two side surfaces (left and right side surfaces) and an upper surface. The upper surface of the locking cap 130 extends in a downwardly inclined manner in a frontward direction. A width between the two side surfaces of the locking cap 130 is larger than a width between the two side surfaces of the body 110.

The locking cap 130 is connected to the front end of the body 110. The locking cap 130 covers a front portion of the body 110 while being connected to the body 110. The locking cap 130 is disposed in front of the spacer 150. The locking cap 130 is disposed in front of the cover 170.

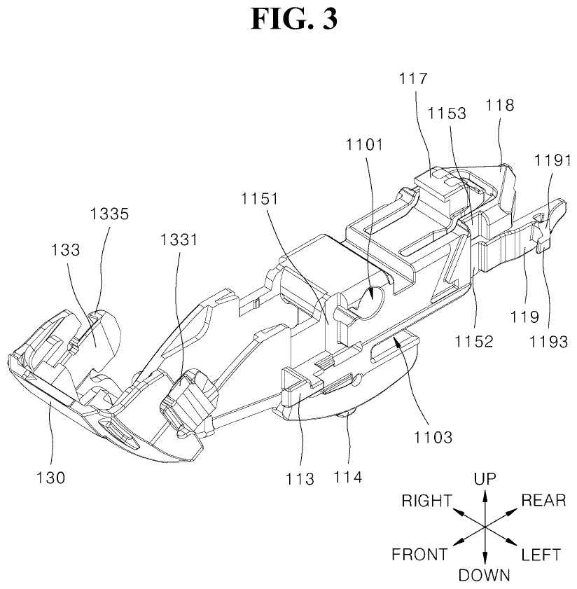

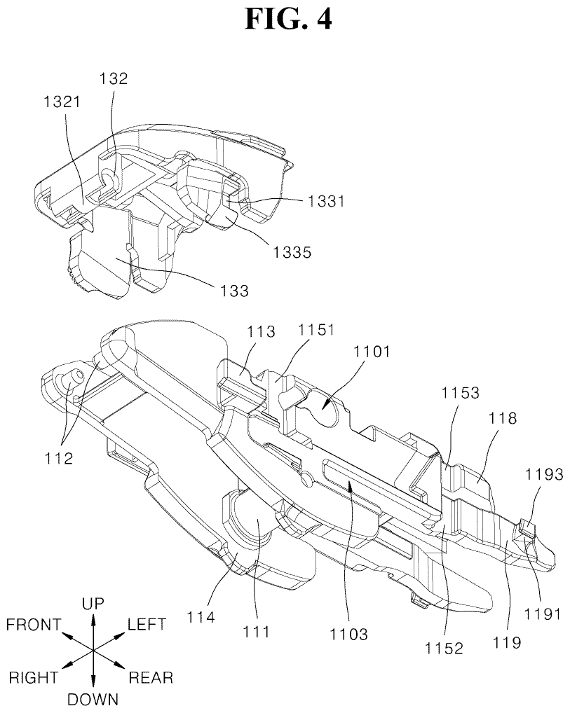

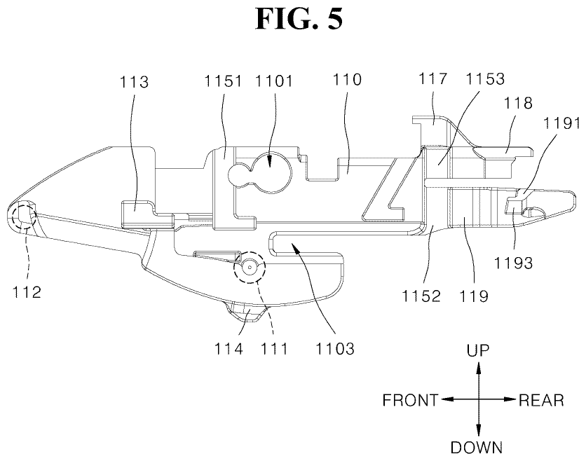

FIG. 3 is a partial perspective view of an adapter according to one embodiment of the present disclosure, FIG. 4 is a partial exploded view of an adapter according to one embodiment of the present disclosure, and FIG. 5 is a side view of an adapter according to one embodiment of the present disclosure.

The body 110 of the adapter 100 according to one embodiment of the present disclosure comprises: a blade coupling shaft 111 rotatably coupled to the wiper blade 200; a pair of locking cap coupling shafts 112 rotatably coupled to the locking cap 130; a first arm coupling groove 1151 recessed into an outer side surface of the body so as to couple the wiper arm to the body; a pair of legs 119 extending in a rearward direction; a second arm coupling groove 1152 recessed into an outer side surface of front portion of the leg 119 so as to couple the wiper arm to the body; a rear top 118 extending rearwardly and disposed above the legs 119; a third arm coupling groove 1153 recessed into an outer side surfaces of a front portion of the rear top 118 so as to connect the wiper arm to the body; a rear hook 117 protruding upwardly and disposed on a front end of the rear top 118; a lower protrusion 114 positioned under the blade coupling shaft 111 and protruding downwardly from a bottom of the body; a button locker 113 fitted into each locking cap button 133; a center hole 1101 extending through the body 110 in the width direction (left and right direction); and a recess 1103 defined in a rear end of the body and recessed in a frontward direction.

According to one embodiment of the present disclosure, the locking cap 130 of the adapter 100 has each locking cap button 133 that extends downwardly, and a locking cap holder 132 into which the locking cap coupling shaft 112 is fitted.

The blade coupling shaft 111 has a cylindrical shape extending in the width direction (left-right direction) of the body 110, and is fitted into the base holder 231 of the base 230. The blade coupling shaft 111 is rotatably coupled to the base holder 231, such that the adapter 100 and the wiper blade 200 are pivotally coupled to each other.

Front and rear portions of the adapter 100 (or the body 110) are determined based on a rotation center of the blade coupling shaft 111, and the blade coupling shaft 111 corresponds to a central portion of the adapter 100 (or the body 110). A portion in front of the blade coupling shaft 111 (the central portion) corresponds to the front portion of the adapter 100 (or the body 110), and a portion in rear of the blade coupling shaft 111 (central portion) corresponds to the rear portion of the adapter 100 (or the body 110). Furthermore, the pivot center of the adapter 100 (or the body 110) means the rotation center of the blade coupling shaft 111.

The blade coupling shaft 111 is disposed at the center of the body 110. The blade coupling shaft 111 is disposed under the center hole 1101 and overlaps therewith in a vertical direction. The blade coupling shaft 111 is disposed above the lower protrusion 114 and overlaps therewith in a vertical direction. The blade coupling shaft 111 is disposed under a rear end of the first arm coupling groove 1151 and overlaps therewith in a vertical direction. The blade coupling shaft 111 is disposed in front of the second arm coupling groove 1152 and the third arm coupling groove 1153.

The locking cap coupling shaft 112 has a cylindrical shape extending in the width direction (left-right direction) of the body 110 and is fitted into the locking cap holder 132 of the locking cap 130. The locking cap coupling shaft 112 is disposed at the front end of the body 110. The locking cap coupling shaft 112 is rotatably coupled to the locking cap holder 132 of the locking cap 130, so that the body 110 and the locking cap 130 are pivotally coupled to each other.

Referring to FIG. 4, the locking cap coupling shaft 112 is provided in pairs. Each of the pair of locking cap coupling shafts 112 protrudes inwardly from each of both opposing inner side surfaces (left and right inner side surfaces) of the body 110. The pair of locking cap coupling shafts 112 are arranged symmetrically with each other in the left-right direction. The pair of locking cap coupling shafts 112 are spaced apart from each other. The locking cap holder 132 of the locking cap 130 has a holder partition wall 1321 disposed between the pair of locking cap coupling shafts 112.

The first arm coupling groove 1151 is disposed in the center of the body 110 and is recessed into each of the both opposing outer side surfaces (left and right outer side surfaces) of the body 110 to connect a specific type of the wiper arm to the body. A portion of the first arm coupling groove 1151 is disposed between the blade coupling shaft 111 and the locking cap coupling shaft 112 in the front-rear direction. The first arm coupling groove 1151 is provided as a pair of the first arm coupling grooves 1151. The pair of the first arm coupling grooves 1151 are arranged symmetrically with each other in the left-right direction while being respectively disposed on both opposing outer side surfaces (left and right outer side surfaces) of the body 110.

The first arm coupling groove 1151 is formed to have an ‘L’ shape in which the groove extends from an upper end to a lower end of the body 110 and extends from the lower end rearwardly. At least a portion of the first arm coupling groove 1151 is positioned above the center of rotation of the blade coupling shaft 111 and overlaps therewith vertically. Referring to FIG. 5, the rear end of the first arm coupling groove 1151 is positioned above the blade coupling shaft 111 and overlaps therewith vertically. A portion of the first arm coupling groove 1151 is positioned between the blade coupling shaft 111 and the locking cap coupling shaft 112 in the front-rear direction.

Each leg 119 is positioned at the rear end of the body 110. Each of both opposing side portions (left and right side portions) of the body 110 extends rearwardly to form each leg 119. The leg 119 is formed to move in an elastic manner in the width direction (left and right direction) of the body 110. The leg 119 is disposed under the rear top 118 and spaced apart from the rear top 118. The leg 119 is provided as a pair of legs, and the pair of legs 119 are arranged symmetrically with each other in the left-right direction.

Each leg 119 has a leg protrusion 1191 formed at a rear end thereof that protrudes from an outer surface thereof laterally and outwardly. The leg protrusion 1191 is engaged with the wiper arm to connect a specific type of the wiper arm to the body.

The leg protrusion 1191 has a leg tip 1193 protruding in a frontward direction. The leg tip 1193 prevents a specific type of the wiper arm from being detached from the body, or prevents the wiper arm from being engaged with the leg protrusion 1191 in an unintended manner. Referring to FIG. 5, the leg tip 1193 protrudes in the frontward direction such that a bottom width is larger than a top width.

The second arm coupling groove 1152 is disposed at the rear portion of the body 110 and is recessed into each of both opposing outer side surfaces (left and right outer side surfaces) of a front portion of the leg 119 to connect a specific type of the wiper arm to the body. The second arm coupling groove 1152 is provided as a pair of second arm coupling grooves 1152, and the pair of second arm coupling grooves 1152 are arranged symmetrically with each other in the left-right direction.

The second arm coupling groove 1152 has an T′ shape in which the groove extends in an elongate manner from the top to the bottom of the outer side surface of the front portion of the leg 119. The second arm coupling groove 1152 has a top open upwardly and a bottom open downwardly. Referring to FIG. 5, the second arm coupling groove 1152 is disposed in rear of the blade coupling shaft 111. The second arm coupling groove 1152 is disposed under the rear hook 117 as the uppermost portion of the body 110. The second arm coupling groove 1152 is disposed under the third arm coupling groove 1153 and spaced therefrom in the vertical direction. The second arm coupling groove 1152 and the third arm coupling groove 1153 overlap each other in the vertical direction and are aligned with each other in a line.

The rear top 118 is disposed at the rear portion of the body 110, and has the upper surface and both opposing outer side surfaces (left and right outer side surfaces) extending in an elongate manner rearwardly. The rear top 118 is disposed under the rear hook 117 and is disposed above the leg 119 and is spaced apart from the leg 119. The rear top 118 is engaged with the wiper arm to connect a specific type of the wiper arm to the body.

The third arm coupling groove 1153 is disposed at the rear portion of the body 110 and is recessed into each of both opposing outer side surfaces (left and right outer side surfaces) of a front portion of the rear top 118 to connect a specific type of the wiper arm to the body. The third arm coupling groove 1153 is provided as a pair of third arm coupling grooves 1153. The pair of third arm coupling grooves 1153 are arranged symmetrically with each other in the left-right direction.

The third arm coupling groove 1153 has an T′ shape that extends in an elongate manner from the top to the bottom of the side surface of the front portion of the rear top 118. The third arm coupling groove 1153 has a top open upwardly and a bottom open downwardly. Referring to FIG. 5, the third arm coupling groove 1153 is disposed in rear of the blade coupling shaft 111. The third arm coupling groove 1153 is disposed under the rear hook 117 as the uppermost portion of the body 110. The third arm coupling groove 1153 is disposed above the second arm coupling groove 1152 and spaced apart from the second arm coupling groove 1152. The second arm coupling groove 1152 and the third arm coupling groove 1153 overlap each other in the vertical direction and are aligned with each other in a line.

The rear hook 117 is disposed at the rear portion of the body 110 and protrudes upwardly from the upper surface of the body 110. Referring to FIG. 5, the rear hook 117 is disposed on top of the third arm coupling groove 1153. The rear hook 117 is disposed in rear of the blade coupling shaft 111.

An upper end of the rear hook 117 may be the uppermost end of the body 110. However, a vertical level of the upper end of the rear hook 117 is equal to or lower than a vertical level of an upper end of the locking cap 130. The rear hook 117 is formed to move in an elastic manner in the vertical direction. The rear hook 117 is engaged with the wiper arm to connect a specific type of the wiper arm to the body. The rear hook 117 elastically couple a specific type of the wiper arm to the body.

Each of the lower protrusion 114 is disposed at the center of the body 110 and protrudes downwardly from a lower end of each of both opposing outer side portions (left and right outer side portions) of the body 110. The lower protrusion 114 is inserted into the base 230 to limit a rotation range of the adapter 100 and to limit the widthwise movement (left and right direction movement) of the body 110 to prevents the body 110 from being removed from the base 230.

Referring to FIG. 5, the lower protrusion 114 is disposed under the blade coupling shaft 111 and overlaps therewith in the vertical direction. The lower protrusion 114 is disposed under the first arm coupling groove 1151 and overlaps therewith in the vertical direction. A lower end of the lower protrusion 114 may be the lowermost end of the body 110 (the adapter 100). The lower protrusion 114 is provided as a pair of lower protrusions, and the pair of lower protrusions 114 are arranged symmetrically with each other in the left-right direction.

Each button locker 113 is disposed at the front portion of the body 110 and protrudes laterally (in the left-right direction) from each of both opposing outer side surfaces (left and right outer side surfaces) of the body 110, and has a front end protruding in the front ward direction. Referring to FIG. 5, the button locker 113 is disposed in front of the first arm coupling groove 1151. The button locker 113 is formed in a stepwise manner so that a dimension in the left-right direction becomes smaller in a stepwise manner as the button locker 113 extends rearwardly.

The button locker 113 is fitted with the locking cap button 133. The front portion of the button locker 113 is inserted into a button groove 1331 of the locking cap button 133, and a lower end thereof is engaged with a button hook 1335. The button locker 113 may be provided as a pair of button lockers, and the pair of button lockers 113 are respectively disposed at both opposing outer side surfaces (left and right outer side surfaces) of the body 110 and are arranged symmetrically with each other in the left-right direction.

The center hole 1101 is disposed at the center portion of the body 110 and is a cylindrical hole that extends in the width direction (left-right direction) through the body 110 so as to connect a specific type of the wiper arm to the body. The center hole 1101 is disposed above the blade coupling shaft 111. The center hole 1101 is disposed above the front end of the recess 1103. The center hole 1101 is disposed in rear of the first arm coupling groove 1151. The center hole 1101 is disposed in front of the second arm coupling groove 1152 and the third arm coupling groove 1153.

The recess 1103 is disposed in the center portion of the body 110 and extends through the body 110 laterally and is recessed in the frontward direction so as to connect a specific type of the wiper arm to the body. Referring to FIG. 5, the front end of the recess 1103 is disposed in rear of the center of the blade coupling shaft 111. The recess 1103 is disposed on above the center of the blade coupling shaft 111. The recess 1103 is disposed in rear of the first arm coupling groove 1151. The recess 1103 is disposed in front of the second arm coupling groove 1152 and the third arm coupling groove 1153. The recess 1103 is provided as a pair of recesses, and the pair of recesses 1103 are arranged symmetrically with each other in the left-right direction while being respectively defined in both opposing side surfaces (left and right side surfaces) of the body 110.

The locking cap buttons 133 respectively extend from the both opposing outer side portions (left and right outer side portions) of the locking cap 130 downwardly. The locking cap button 133 is formed to move in an elastic manner in the width direction (left-right direction) of the locking cap 130. The locking cap button 133 is provided as a pair of the locking cap buttons 133. The pair of locking cap buttons 133 are symmetrically arranged symmetrically with each other in the left-right direction.

The locking cap button 133 has the button groove 1331 recessed into an outer side surface thereof. The button locker 113 is fitted into the button groove 1331. The button hook 1335 in a shape of a hook protruding in the width direction (left-right direction) is formed at a bottom of the button groove 1331. The button hook 1335 is engaged with the button locker 113.

The locking cap button 133 has a protrusion formed on an outer surface of a portion thereof where the button groove 1331 and the button hook 1335 are not formed. A lower portion of the locking cap button 133 is formed so that a thickness thereof becomes smaller as the lower portion extends downwardly.

The locking cap holder 132 is fitted with the locking cap coupling shaft 112. The locking cap holder 132 has a “C” shape with an open bottom. The locking cap holder 132 has the holder partition wall 1321 formed in the center thereof. The holder partition wall 1321 is disposed between the pair of locking cap coupling shafts 112 so as to space the pair of locking cap coupling shafts 112 from each other. The pair of locking cap coupling shafts 112 are coupled to the locking cap holder 132 while the holder partition wall 1321 is disposed therebetween, such that deformation of the pair of locking cap coupling shafts 112 or detachment thereof from the locking cap due to twist thereof is prevented.

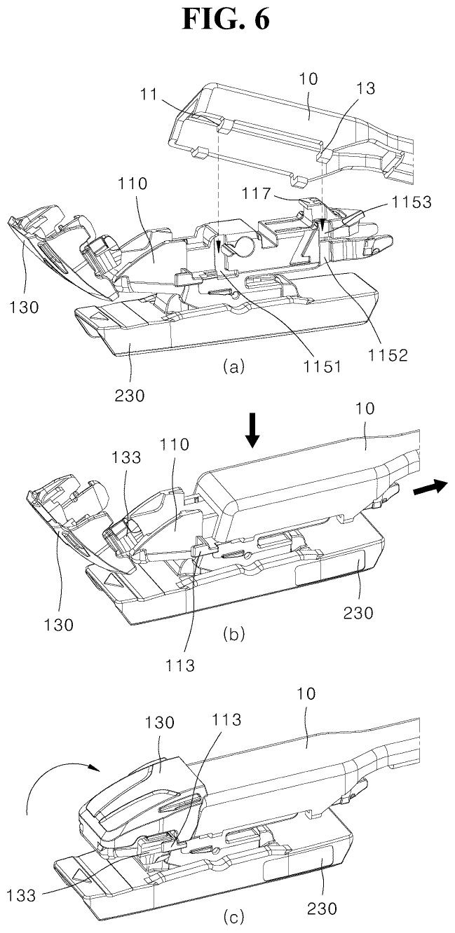

FIG. 6 is a drawing showing that a wiper arm is connected to an adapter in a wiper device according to one embodiment of the present disclosure.

Referring to a of FIG. 6, a wiper arm 10 of a wiper device according to one embodiment of the present disclosure has a front portion composed of an upper portion and both opposing side portions (left and right side portions). The wiper arm 10 has a pair of front arm protrusions 11 and a pair of rear arm protrusions 13.

Each of the pair of front arm protrusions 11 extends downward from a lower end of a side surface of the wiper arm 10 and then protrudes inwardly. Each of the pair of front arm protrusions 11 is formed in an “L” shape. The pair of front arm protrusions 11 are symmetrically arranged with each other in the left-right direction while being respectively disposed on both opposing side surfaces of the wiper arm 10.

Each of the pair of rear arm protrusions 13 extends downwardly from the lower end of the side surface of the wiper arm 10 and then protrudes inwardly. Each of the pair of rear arm protrusions 13 is formed in an “L” shape. The pair of rear arm protrusions 13 are symmetrically arranged with each other in the left-right direction while being respectively disposed on both opposing side surfaces of the wiper arm 10.

The pair of rear arm protrusions 13 are spaced apart from the pair of front arm protrusions 11 and are disposed in rear of the pair of front arm protrusions 11.

The wiper arm 10 in this embodiment has a structure of one type of the wiper arm 10 among various types of wiper arms. A method of connecting the wiper arm 10 to the adapter 100 varies depending on the type of the wiper arm.

Hereinafter, with reference to FIG. 6, the method of connecting the wiper arm 10 of this embodiment to the adapter 100 will be described.

When the user presses the pair of locking cap buttons 133 of the locking cap 130 while the cover 170 and the spacer 150 of the adapter 100 have been removed from the adapter, the locking cap button 133 is removed from the button locker 113 of the body 110, such that the locking cap 130 pivots, and thus, the locking cap 130 opens the body 110 as shown in (a) of FIG. 6.

As shown in (a) of FIG. 6, the user aligns the pair of front arm protrusions 11 of the wiper arm 10 with the pair of first arm coupling grooves 1151 of the body 110 and aligns the pair of rear arm protrusions 13 of the body 110 with the pair of third arm coupling grooves 1153.

As shown in (b) of FIG. 6, when the user displaces the wiper arm 10 downwardly and inserts the wiper arm 10 into the body 110, the pair of front arm protrusions 11 move to the lower ends of the pair of first arm coupling grooves 1151, and the pair of rear arm protrusions 13 pass through the third arm coupling grooves 1153 and then the second arm coupling grooves 1152. Thereafter, when the user moves the wiper arm 10 backwardly, the pair of front arm protrusions 11 are inserted into the horizontal portion extending in the rearward direction of each of the pair of first arm coupling grooves 1151.

As shown in (c) of FIG. 6, when the user pivots the locking cap 130 to insert the locking cap button 133 into the button locker 113, the locking cap 130 closes the body 110, and thus the front end of the wiper arm 10 is fixedly disposed between the locking cap 130 and the body 110.

When the wiper arm 10 is connected to the adapter 100, the rear hook 117 having the elasticity is pressed against the upper surface of the wiper arm 10, thereby reducing a clearance between the wiper arm 10 and the adapter 100.

Although embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above is not restrictive but illustrative in all respects.

1. An adapter for connecting a wiper blade to a wiper arm, the adapter comprising:
a body coupled to the wiper blade, wherein the wiper arm is detachably connected to the body; and
a locking cap pivotally coupled to a front of the body,
wherein the body has:
a blade coupling shaft rotatably coupled to the wiper blade;
a pair of locking cap coupling shafts rotatably coupled to the locking cap; and
a first arm coupling groove recessed in an outer side surface of the body,
wherein a portion of the first arm coupling groove is positioned between the blade coupling shaft and the locking cap coupling shaft.

2. The adapter of claim 1, wherein the first arm coupling groove has an L shape having:
a vertical portion extending in an elongate manner vertically from a top to a bottom; and
a horizontal portion extending rearwardly from the bottom.

3. The adapter of claim 2, wherein a rear end of the first arm coupling groove is above the blade coupling shaft.

4. The adapter of claim 1, wherein the pair of locking cap coupling shafts respectively protrude inwardly from both opposing inner side surfaces of the body.

5. The adapter of claim 4, wherein the locking cap has a locking cap holder into which the pair of locking cap coupling shafts are inserted,
wherein the locking cap holder has a holder partition wall formed in a center thereof, wherein the holder partition wall is disposed between the pair of locking cap coupling shafts.

6. The adapter of claim 1, wherein the body has a leg extending rearwardly,
wherein the leg has a leg protrusion formed at a rear end of the leg and protruding laterally,
wherein the leg protrusion has a leg tip protruding frontward.

7. The adapter of claim 6, wherein the body has a second arm coupling groove recessed into an outer side surface of a front of the leg.

8. The adapter of claim 7, wherein the body has a rear top extending rearwardly, wherein the rear top is spaced apart on the legs,
wherein the body has a third arm coupling grooves recessed into an outer side surface of a front of the rear top.

9. The adapter of claim 1, wherein the locking cap has a locking cap button extending downwardly,
wherein the locking cap button has a button groove recessed into an outer side surface thereof,
wherein the body has a button locker inserted into the button groove.

10. The adapter of claim 9, wherein the button locker is positioned in front of the first arm coupling groove.
